(19) United States
(12) Patent Application Publication
(10) Pub. No.: US 2014/0144376 A1
(43) Pub. Date: May 29, 2014

(54) MOBILE APPARATUS WITH LOCAL POSITION REFERENCING ELEMENTS

(71) Applicant: GREGORY MICHAEL BURKE, San Diego, CA (US)

(72) Inventor: GREGORY MICHAEL BURKE, San Diego, CA (US)

(21) Appl. No.: 13/686,986

(22) Filed: Nov. 28, 2012

(51) Int. Cl. B25J 11/00; B26D 5/00

(52) U.S. Cl. CPC B25J 11/0075; B26D 5/007; Y10S 901/01
USPC 118/323; 180/169; 83/365; 901/1

(57) ABSTRACT

A position-referenced mobile system includes a mobile apparatus having: a chassis having a first edge and a second edge opposite the first edge; a first wheel rotatably mounted proximate the first edge of the chassis; a second wheel rotatably mounted proximate the second edge of the chassis; a first motor for rotating the first wheel; a second motor for rotating the second wheel; a first encoder for monitoring an amount of rotation of the first motor; a second encoder for monitoring an amount of rotation of the second motor; a laser mounted on the chassis; and a photo detector mounted on the chassis; a controller for interpreting signals provided by the photo detector; and a plurality of reflective elements disposed at a corresponding plurality of locations that are observable by the photo detector when the mobile apparatus is located within a position detection region.

### CROSS REFERENCE TO RELATED APPLICATIONS

Reference is made to commonly assigned, co-pending U.S. patent application Ser. No. ______ (K001391), concurrently filed herewith, entitled “Method of Positioning a Mobile Apparatus” by Greg Burke; co-pending U.S. patent application Ser. No. ______ (K001354), concurrently filed herewith, entitled “Mobile Apparatus with Local Position Referencing Structure” by Greg Burke; and co-pending U.S. patent application Ser. No. ______ (K001392), concurrently filed herewith, entitled “Determining a Position of a Mobile Apparatus” by Greg Burke, et al, the disclosures of which are herein incorporated by reference.

### FIELD OF THE INVENTION

This invention relates generally to the field of motion-controlled mobile units, and more particularly to a mobile apparatus whose motion is controlled with reference to local position referencing elements.

### BACKGROUND OF THE INVENTION

A mobile apparatus can be controlled to perform an operation as a function of a position of the mobile apparatus. Such operations can include modifying a surface over which the mobile apparatus is moved, ejecting a liquid onto a medium, printing an image, fabricating a device, or cutting a surface for example. The accuracy to which the position of the mobile apparatus must be known depends upon the operation to be performed and the quality of the resulting output that is required. For example, the print quality of a sign that is to be viewed at a long distance does not require as high a degree of positional accuracy of printing as does a poster-sized print of a photographic image. In addition, the placement of different portions of an image that are separated by white space is not as critical of the placement of different portions of an image that are adjacent to each other and printed on separate printing swaths.

U.S. Pat. No. 6,116,707 discloses a robotic plotting system in which a printhead is placed on a substantially flat horizontal surface upon which a recording medium is placed. The robotic plotter printhead is directed across the medium by infrared, ultrasound or microwave signals that are transmitted to the printhead from the periphery of the recording medium. The printhead includes a motorized drive mechanism that propels it across the surface of the recording medium using control signals. U.S. Pat. No. 6,951,375 discloses a wheeled vehicle that includes motors, encoders, and an inkjet printhead for printing on a large surface area or walkway.

What is needed is a more accurate way of determining the position of a mobile apparatus for performing an operation, such as printing, as a function of the position of the mobile apparatus. It is also advantageous for position referencing elements to be configured such that they can be placed in somewhat arbitrary locations to define a position detection region for the mobile apparatus.

### SUMMARY OF THE INVENTION

The present invention is directed to overcoming one or more of the problems set forth above. Briefly summarized, according to one aspect of the invention, the invention resides in a position-referenced mobile system comprising: a mobile apparatus including: a chassis having a first edge and a second edge opposite the first edge; a first wheel rotatably mounted proximate the first edge of the chassis; a second wheel rotatably mounted proximate the second edge of the chassis; a first motor for rotating the first wheel; a second motor for rotating the second wheel; a first encoder for monitoring an amount of rotation of the first motor; a second encoder for monitoring an amount of rotation of the second motor; a laser mounted on the chassis; and a photo detector mounted on the chassis; a controller for interpreting signals provided by the photo detector; and a plurality of reflective elements disposed at a corresponding plurality of locations that are observable by the photo detector when the mobile apparatus is located within a position detection region.

According to another aspect of the present invention, the invention resides in a position-referenced mobile system comprising: a mobile apparatus including: a chassis having a first edge and a second edge opposite the first edge; a first wheel rotatably mounted proximate the first edge of the chassis; a second wheel rotatably mounted proximate the second edge of the chassis; at least a first motor for rotating the first wheel and the second wheel; at least a first encoder for monitoring an amount of rotation of either a shaft of the first motor or the first wheel; and a photo detector mounted on the chassis; a controller for interpreting signals provided by the photo detector; and a plurality of light providing elements disposed at a corresponding plurality of locations that are observable by the photo detector when the mobile apparatus is located within a position detection region.

### BRIEF DESCRIPTION OF THE DRAWINGS

In the detailed description of the preferred embodiments of the invention presented below, reference is made to the accompanying drawings, in which:

FIG. 1 schematically shows a position-referenced mobile system according to an embodiment of the invention;

FIG. 2 schematically shows a rotary encoder;

FIG. 3 is a top view that schematically shows the mobile apparatus in two different locations and orientations relative to a reflective cylinder according to an embodiment of the invention;

FIG. 4 schematically shows a top view of four reflective cylinders and their relationship to two successive locations A and B of the mobile apparatus;

FIG. 5 illustrates how coordinates of a reflective cylinder are calculated;

FIG. 6 shows an embodiment similar to FIG. 4 but with light sources instead of reflective cylinders;

FIG. 7 shows a bottom view of the mobile apparatus including an operating device for performing an operation as a function of position of the mobile apparatus; and

FIG. 8 schematically shows mobile apparatus travelling in a serpentine pattern and recalibrating its position as it turns around at the end of a swath.

### DETAILED DESCRIPTION OF THE INVENTION

The present description will be directed in particular to elements forming part of, or cooperating more directly with, apparatus in accordance with the present invention. It is to be understood that elements not specifically shown or described may take various forms well known to those skilled in the art.

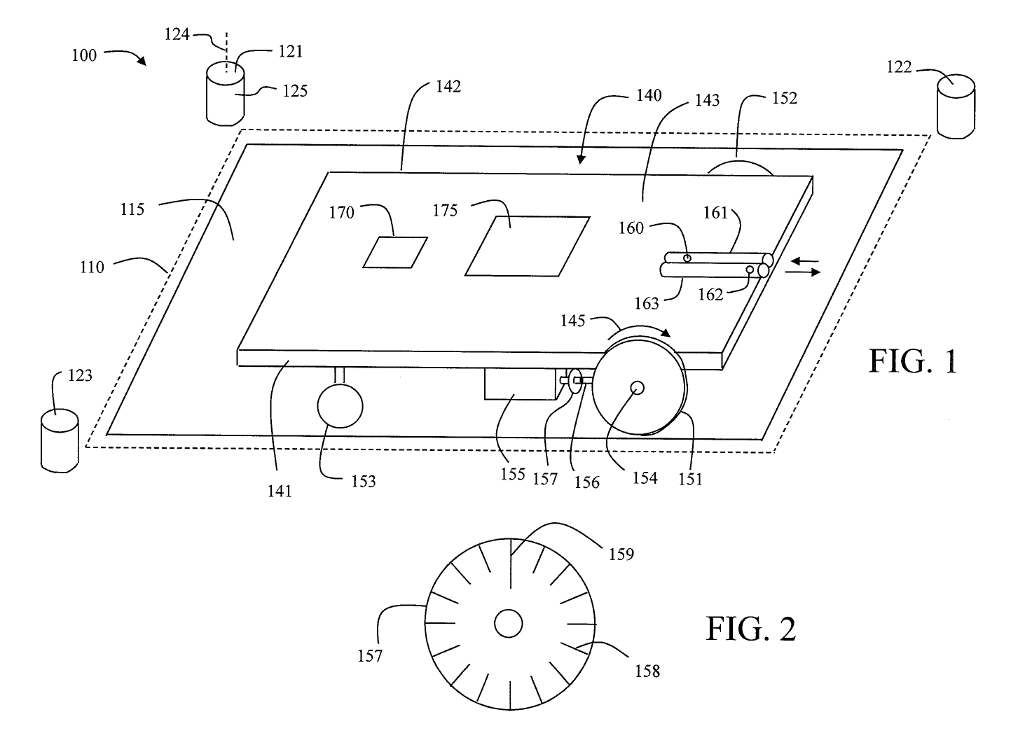

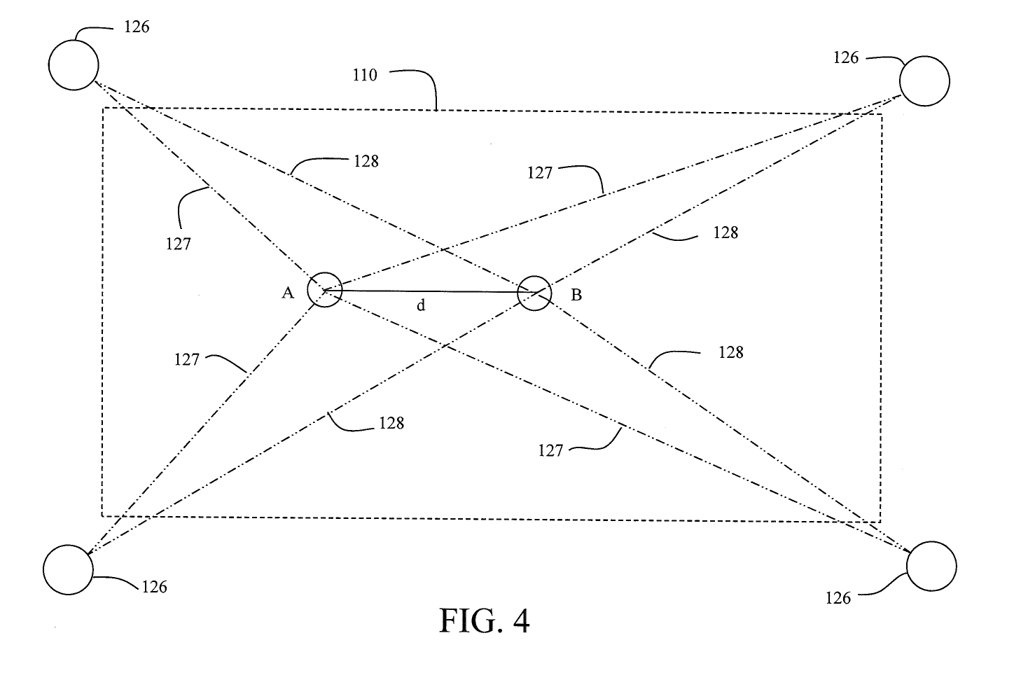

FIG. 1 schematically shows a position-referenced mobile system 100 including a mobile apparatus 140, a controller 170 and a plurality of reflective elements 121, 122 and 123 according to an embodiment of the present invention. The mobile apparatus 140 is located within a position detection region 110, which can include a sheet of medium 115 lying flat on a horizontal table or floor for example. It is noted that FIG. 1 is not drawn to scale. The mobile apparatus 140 is shown artificially large compared to the position detection region 110 so that details of the mobile apparatus 140 can be seen more clearly. A typical length of the mobile apparatus 140 can be around several inches, while a typical length and width of the position detection region 110 can be around several feet. It is noted that the plurality of reflective elements 121, 122 and 123 are preferably reflective cylinders 126 (see FIG. 4) having cylindrical surfaces 125.

The mobile apparatus 140 includes a chassis 143 having a first edge 141 and a second edge 142 that is opposite the first edge 141. A first wheel 151 is rotatably mounted near the first edge 141 and a second wheel 152 is rotatably mounted near the second edge 142. A first motor 155 provides power to rotate the first wheel 151 about a hub 154. A second motor 155 (not visible in FIG. 1) provides power to rotate the second wheel 152 independently of the first wheel 151. Both the first wheel 151 and the second wheel 152 can be independently driven by their respective motors 155 in a first rotational direction 145 (forward) or in a second rotational direction (reverse) opposite the first rotational direction 145. Driving the first wheel 151 in a first rotational direction 145 while also driving the second wheel 152 in the first rotational direction 145 causes the mobile apparatus 140 to move from one location to a different location. Driving the first wheel 151 in the first rotational direction 145 while driving the second wheel 152 in the second rotational direction that is opposite the opposite rotational direction causes the mobile apparatus 140 to rotate to a different orientation. In another embodiment not shown, a first motor drives both the first wheel 151 and the second wheel 152 by having a differential drive to send power to both the first and second wheels 151, 152, but then allowing one or the other wheel to be stopped via a separate clutch or brake for rotation. Referring back to the preferred embodiment of FIG. 1, at least one freely rotating ball 153 helps to support the chassis 143 and is able to turn in any direction as required by movement of the driven first and second wheels 151 and 152. The freely rotating ball 153 is shown in FIG. 1 as being near the first edge 141. There can also be another freely rotating ball 153 (not shown) near the second edge 142. In other embodiments, a freely rotating ball (not shown) can be more centrally between the first edge 141 and the second edge 142.

Referring to FIGS. 1 and 2, a first rotary encoder 157 (FIG. 2) is mounted on a shaft 156 of the first motor 155 in order to monitor an amount of rotation of the first motor 155 and the first wheel 151. The rotary encoder 157 typically includes a plurality of radial lines 158 disposed around a circumference of a disk. An optical sensor (not shown) detects rotation of the disk by high signals corresponding to light passing through transparent regions of the disk or low signals corresponding to light being blocked by the radial lines 158. For simplicity in FIG. 2, the lines 158 are shown as being spaced about every 22.5 degrees. In actual rotary encoders, the lines 158 are typically spaced about every degree. The rotary encoder 157 typically includes a detectable reference position 159. In the configuration shown in FIG. 2, the detectable reference position 159 is shown as the elongated radial line 158. A second rotary encoder 157 is mounted on a shaft of the second motor (not visible in FIG. 1) to monitor an amount of rotation of the second motor and the second wheel 152. Monitoring the first and second rotary encoders 157 while driving the first wheel 151 and the second wheel 152 in the same rotational direction (and knowing the diameters of the wheels), allows the calculation of a distance moved by the mobile apparatus 140. Monitoring the first and second rotary encoders 157 while driving the first wheel 151 and the second wheel 152 in opposite rotational directions (and knowing a distance between the wheels), allows the calculation of an amount of rotation by the mobile apparatus 140.

A photo detector 160 and a laser 162 are also mounted on the chassis 143. In the configuration shown in FIG. 1, the photo detector 160 is disposed within a hollow tube 161, and the laser 162 is disposed within a cylindrical package 163. The hollow tube 161 is parallel to the cylindrical package 163 and is adjacent to it. It is not required that the laser 162 have the cylindrical package 163, but such a package shape can be helpful in aligning the laser 162 such that its beam is emitted substantially parallel to hollow tube 161. The hollow tube 161 is opaque in order to reduce the amount of stray light impinging on the photo detector 160 so that primarily the light received by photo detector 160 is light from the laser 162 that is reflected from the cylindrical surface 125 of the reflective cylinder 126 (see FIG. 4). A typical diameter of the hollow tube 161 and of the emitted beam from the laser 162 is about 3 millimeters. In the schematic view of FIG. 1, the hollow tube 161 and the cylindrical package 163 are shown as transparent so that the photo detector 160 and the laser 162 can be indicated. The controller 170, which in the embodiment shown in FIG. 1, is mounted on the mobile apparatus 140, interprets electrical signals provided by the photo detector 160 and makes calculations to determine the position of the mobile apparatus 140. The controller 170 also interprets signals from the rotary encoders 157, sends signals for motors 155 for moving or rotating mobile apparatus 140, and provides overall control of the operation of the mobile apparatus 140. A power source 175 is also mounted on the mobile apparatus 140 and provides power for the motors 155, controller 170, laser 162, and other devices associated with the operation of mobile apparatus 140.

In the configuration shown in FIG. 1, the reflective elements 121, 122 and 123 are shown as being positioned at locations that are near to but outside of the position detection region 110. The reflective elements 121, 122 and 123 are observable by the photo detector 160 when mobile apparatus 140 is located within the position detection region 110. However, a strong light signal will only be detected by the photo detector 160 when the laser 162 and the hollow tube 161 are pointed toward one of the reflective elements 121, 122 or 123. Optionally, a color filter (not shown) can be included in front of the photo detector 160 in order to filter out wavelengths that do not correspond to the laser 162. In a preferred embodiment, a reflective surface of the reflective element 121 is cylindrical, and similarly for reflective elements 122 and 123. An advantage of a reflective cylindrical surface is that as the orientation of the hollow tube 161 and the laser 162 changes, for example, as the mobile apparatus 140 is rotated, a strong light signal will be detected by the photo detector 160 over a very small range of angles where the incident and the reflected laser beam are substantially perpendicular to the cylindrical surface 125. Light reflecting from the surface of the cylinder along a direction that can be received into the hollow tube 161 is in the direction of a vector passing through the center of the cylinder, so that the radius of the cylinder is not important. The reflected laser beam has a narrow width so that errors resulting from beam width are small. Detecting an amplitude of light includes analyzing a signal from the photo detector 160 (corresponding to reflected laser light) as a function of the orientation of the hollow tube 161.

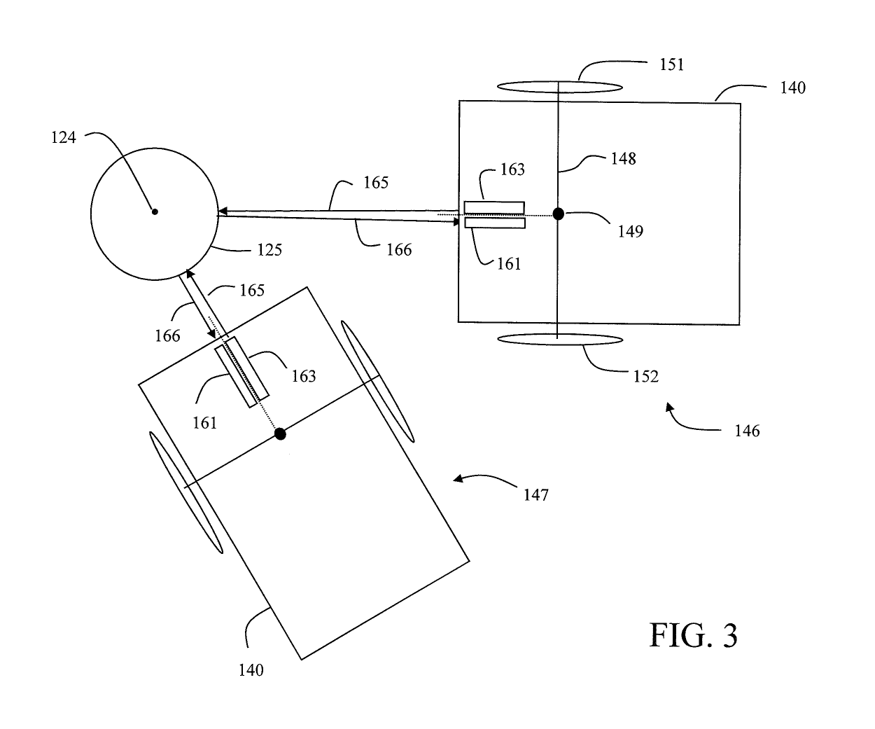

The top view shown in FIG. 3 schematically shows the mobile apparatus 140 in two different positions relative to the reflective cylindrical surface 125. In a first position 146 of the mobile apparatus 140 a strong reflected beam 166 is received in the hollow tube 161 corresponding to the photo detector 160 (see FIG. 1) if the incident beam 165 is emitted from the laser 162 (see FIG. 1) along a right to left orientation in FIG. 3 when the laser 162 is turned on. In a second position 147, it is necessary to rotate the mobile apparatus 140 into an orientation such that the incident beam 165 travels from the lower right of a cylindrical surface 125 so that a strong reflected beam 166 is received by the photo detector 160 in the hollow tube 161. Although the incident beam 165 is reflected from cylindrical surface 125, the reflected beam 166 appears to emanate from axis 124 (see FIGS. 1 and 3) and subtends a narrow range of angles. Rotation of the mobile apparatus 140 can be done by rotating the first wheel 151 in a first rotational direction (e.g. forward) while rotating the second wheel 152 in an opposite rotational direction (e.g. reverse). Rotation of the mobile apparatus 140 occurs about a center of rotation 149 that is centrally located between the first wheel 151 and the second wheel 152. It can be advantageous for the hollow tube 161 corresponding to the photo detector 160 and the laser 162 to be aimed in a forward direction. As indicated in FIG. 3, this means that the hollow tube 161 is perpendicular to or substantially perpendicular to a line 148 that joins a central portion of the first wheel 151 and a central portion of the second wheel 152 as seen in a top view. This statement is meant to include configurations where a line joining the hubs 154 (FIG. 1) of the first wheel 151 and the second wheel 152 is in a different plane than the plane in which the hollow tube 161 and the laser 162 reside, but a projection of the line between the hubs 154 as seen from a top view is perpendicular to or substantially perpendicular to the hollow tube 161.

FIG. 4 schematically shows a top view of four reflective cylinders 126 located outside of, but near position detection region 110. Position detection region 110 can also be called a work space, since it corresponds to a region in which mobile apparatus 140 (FIG. 1) can move and operate as a function of its position. A first step in determining positions within position detection region 110 is to determine the positions of the reflective cylinders 126. An advantage of the configuration shown in FIG. 4 (whether there are four reflective cylinders 126, three reflective cylinders 126, or some other number of reflective cylinders 126), is that the reflective cylinders 126 can be placed in somewhat arbitrary locations.

In that way, the user can define work spaces of various sizes and shapes. The user also does not need to place the reflective cylinders 126 precisely in specific locations.

With reference to FIGS. 1, 2 and 4, in order to determine the position of the reflective cylinders 126, the mobile apparatus 140 is moved to a location A. The hollow tube 161 and the laser 162 are then rotated (for example by rotating mobile apparatus 140) while monitoring the angle of rotation (for example using the rotary encoders 157 on the shafts 156 of the motors 155 for the first and second wheels 151 and 152). Amplitude of light reflected by the plurality of reflective cylinders 126 is detected by the photo detector 160 as a function of the amount of rotation at location A. Orientations where strong signals are detected in photo detector 160 are noted, as represented by signal detection lines 127 in FIG. 4, corresponding to reflections of laser beams from the reflective cylinders 126 while the mobile apparatus 140 is at location A. Then the mobile apparatus 140 is moved by a known distance d along a given heading from location A to location B, that is by driving the first wheel 151 and the second wheel 152 in the same rotational direction by a known amount. Distance d can be measured by monitoring the rotary encoders 157 while rotating both the first wheel 151 and the second wheel 152 in a first rotational direction 145 (e.g. forward) and knowing the diameters of the first wheel 151 and the second wheel 152. At location B, the first and second hollow tubes 161 are again rotated (for example by rotating mobile apparatus 140) while orientations of strong signals (signal detection lines 128) are monitored by the photo detector 160 as a function of amount of rotation.

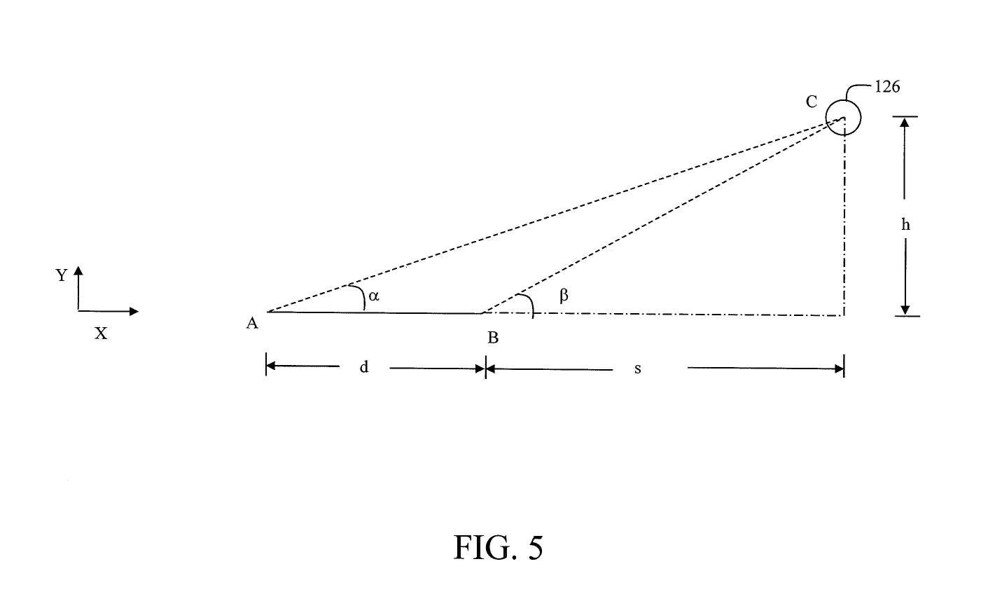

Calculation of the position of each of the reflective cylinders 126 can be done by the controller 170 (FIG. 1) as illustrated in FIG. 5 for one reflective cylinder 126. Angle α is measured as described above while the mobile apparatus 140 (FIG. 1) is at location A. Then mobile apparatus 140 is moved by a known distance d to location B and angle β is measured. Define an (X,Y) coordinate system such that location A is at the origin and the line segment AB, which extends along the given heading, is along the X axis. In other words location A has coordinates (0,0) and location B has coordinates (d,0). Let the coordinates of the reflective cylinder 126 at location C be (d+s, h). In other words, location C is a distance h above the X axis, and a perpendicular line from location C intercepts the X axis at an X coordinate of d+s. From FIG. 5 it can be seen that:

h=(d+s)tan α (1) and

h=s tan β (2), so that

s=d tan α/(tan β−tan α) (3). Then

Y(C)=h=d tan α tan β/(tan β−tan α) (4) and

X(C)=d+s=d tan β/(tan β−tan α) (5).

In this fashion, the (X,Y) coordinates of each of the reflective cylinders 126 (whether four reflective cylinders 126 as in FIG. 4, or some other number) can be readily calculated. This provides the coordinates of all references of a local reference system. Then if the mobile apparatus 140 (FIG. 1) is moved to an arbitrary third location, rotated at the third location while monitoring an amount of rotation, and detecting an amplitude of light from at least two (and preferably at least three) of the reflective cylinders 126 as a function of the amount of rotation at the third location, a position of the third location can be calculated using trigonometric relationships. If the position of the location immediately previous to the third location is known and the mobile apparatus 140 has been moving in a straight line, then the heading of the mobile apparatus 140 at the third location can also be calculated.

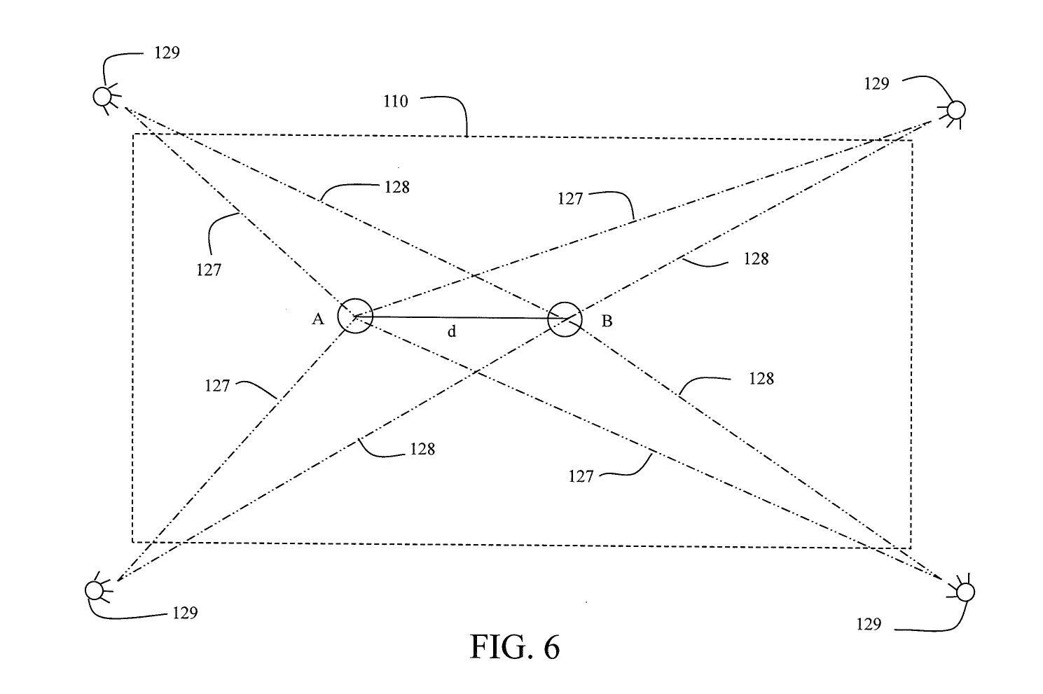

In another embodiment illustrated in FIG. 6, the reflective cylinders 126 are replaced by light sources 129, and the laser 162 (FIG. 1) is not needed. Position calculations can be done in a way similar to that described above where the reflective cylinders 126 were used as position references. An additional step is to turn on the light sources 129. In some embodiments, using light sources 129 does not provide as accurate position calculations as are possible using the laser 162 and the reflective cylinders 126, because the light sources 129 subtend a larger range of angles as seen by the photo detector 160 (FIG. 1). A generic term used herein for the light sources 129 or reflective members such as reflective cylinders 126 used as position references is “light providing elements”. Light sources 129 provide light by generating it. The reflective elements 121 provide light by reflecting it from the laser 162.

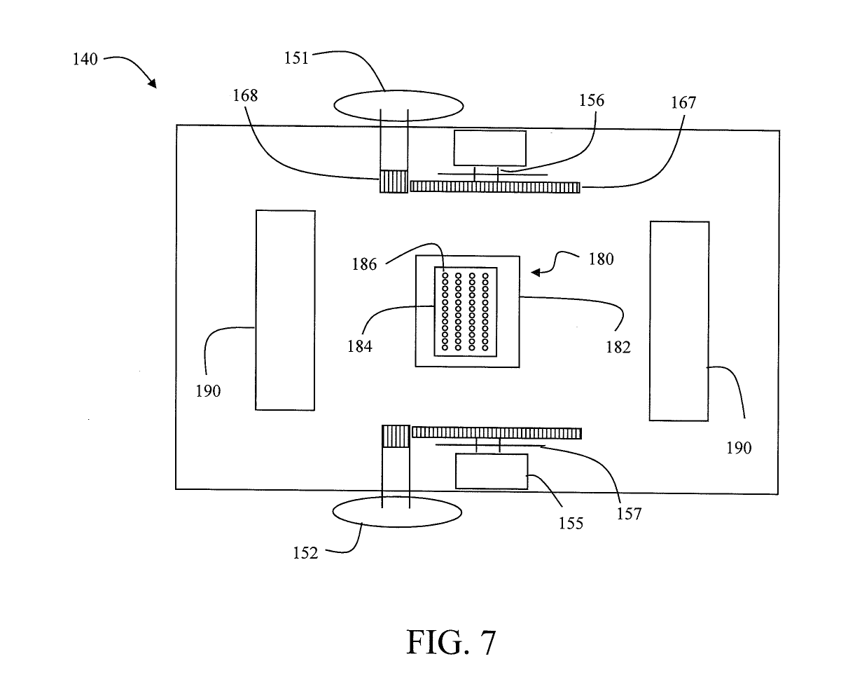

A bottom schematic view of the mobile apparatus 140 is shown in FIG. 7. The first wheel 151 and the second wheel 152 are shown with their respective wheel gears 168. The first motor 155 drives the first wheel 151 via a motor gear 167 that engages the wheel gear 168. The rotary encoder 157 on the shaft 156 monitors the amount of wheel rotation by measuring the amount of motor rotation. Similarly, the second motor 155 drives the second wheel 152 via a motor gear 167 that engages the wheel gear 168. The rotary encoder 157 on the shaft 156 monitors the amount of wheel rotation by measuring the amount of motor rotation. The first and second wheels 151 and 152 can therefore be driven and monitored independently of each other. Also shown in FIG. 7 is an operating device 180 for performing an operation directed by the controller 170 (FIG. 1) as a function of detected position of the mobile apparatus 140. In the example shown in FIG. 7, an operating device 180 includes a marking device. In particular, the marking device is a printhead 182 having a printhead die 184 containing an array of nozzles 186 for ejecting drops of liquid. The drops of liquid can include colored inks, such that ejecting at least one drop of liquid as a function of location of the mobile apparatus 140 includes printing a portion of an image on a sheet of the medium 115 (FIG. 1) with which the first and second wheels 151 and 152 are in contact. Alternatively the drops of liquid can include solutions including conductive particles, resistive particles, insulating particles, semiconducting particles or magnetic particles for functional printing as a function of location of the mobile apparatus 140 in order to fabricate a device or a circuit according to control signals by controller 170 (FIG. 1). More generally performing an operation by the operating device 180 includes modifying a surface (such as a surface of sheet of the medium 115) over which the mobile apparatus 140 is moved. Modifying the surface can include marking the surface, depositing liquid drops on the surface (as described above), illuminating the surface, heating the surface, or cutting the surface for example. Alternative types of operating devices 180 (in addition to a printhead 182 for depositing liquid drops) include a laser for illumination or heating, or a blade for cutting the surface. Also shown in FIG. 7 is at least one photosensor array 190 for detecting an edge of sheet of the medium 115 in order to properly position the surface modification relative to sheet of the medium 115. The photosensor array 190 can also provide feedback about previously modified or marked regions of sheet of the medium 115.

A method of performing an operation by the operating device 180 on the mobile apparatus 140 as a function of position of the mobile apparatus 140 has been provided. The method includes determining successive positions of the mobile apparatus 140 as described above with reference to FIGS. 1, 2 and 4. In particular, a position of a third location is calculated based on the calculated position of at least two of the light providing elements (reflective cylinders 126 or light sources 129). A signal is then sent from the controller 170 to the operating device 180 to perform an operation corresponding to the third location. Then the mobile apparatus 140 is moved from the third location in a known direction by a known distance (monitoring the rotary encoders 157) to arrive at a fourth location. A signal is sent from the controller 170 to the operating device 180 to perform an operation corresponding to the fourth location. The process of moving to a new location and performing an operation corresponding to that location is typically repeated many times to complete a task such as printing an image on a sheet of the medium 115.

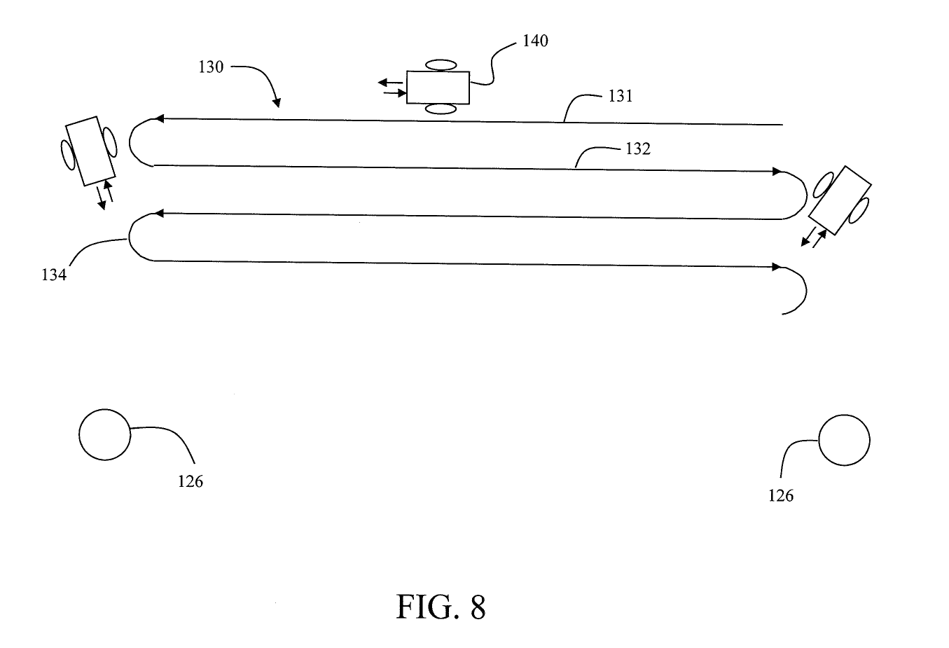

FIG. 8 shows the mobile apparatus 140 traveling in a serpentine pattern 130 of a type that that can be used for printing an image in multiple adjacent swaths, for example. The serpentine pattern 130 includes straight portions in a first direction 131 that are parallel to straight portions in a second direction 132 that is opposite to the first direction. Straight portions in the first direction 131 are joined to straight portions in the second direction 132 by turn-around portions 134 in which the mobile apparatus 140 is rotated by 180 degrees by moving it around a semicircle. The controller 170 keeps track of position and heading for the cumulative moves of the mobile apparatus 140 based on monitoring the rotary encoders 157 for the first wheel 151 and the second wheel 152. However, due to factors such as wheel slippage there will be some amount of error in the (X,Y) position as well as the heading of the mobile apparatus 140. Typically, additional error will be accumulated at every turn in the serpentine pattern 130. As a result, straight portions in the first direction 131 and straight portions in the second direction 132 will not be truly parallel to each other as needed for accurate positioning of the mobile apparatus 140. However, because the (X,Y) coordinates of each of the reflective cylinders 126 (or other light providing elements) have been previously determined as described above relative to FIGS. 1, 2 and 4, these known positions can be used to correct the current errors in heading and (X,Y) position of the mobile apparatus 140. As the mobile apparatus 140 is rotating in the turn-around portions 134, the hollow tube 161 with the photo detector 160 is also being swept through a range of orientations so that it can detect signals from light providing elements such as reflected laser light from the reflective cylinders 126 or from the light sources 129 in embodiments similar to FIG. 6. In particular while moving along the serpentine pattern 130, the mobile apparatus 140 is moved by a known distance along straight portion in the first direction 131. Then mobile apparatus 140 is rotated by 180 degrees as it moves around a semicircle while detecting an amplitude of light signal from at least two light providing elements (such as reflective cylinders 126) as a function of the amount of rotation. The position and heading of the mobile apparatus 140 can thereby be recalibrated, comparing position and heading data stored in the controller 170 to the measurements relative to the reflective cylinders 126, prior to moving mobile apparatus along the straight portion in second direction 132. Errors in Y are corrected by changing the radius of the next turn by controlling the motors 155 to appropriately adjust the speed and direction of first wheel 151 and second wheel 152. Heading error is corrected by changing the angle of the next turn by controlling the duration of the motors 155 moving mobile apparatus substantially in a semicircle. Error in X (that is, the position at which a particular operation occurs) are corrected by changing the starting position of the operation for that swath, as well as the length of move during which the operation occurs along the swath.

The present invention has been described in detail with particular reference to certain preferred embodiments thereof, but it will be understood that variations and modifications can be effected within the scope of the invention.

### PARTS LIST

100 Position-referenced mobile system
110 Position detection region
115 Sheet of medium
121 Reflective element
122 Reflective element
123 Reflective element
124 Axis
125 Cylindrical surface
126 Reflective cylinder(s)
127 Signal detection line(s) (at location A)
128 Signal detection line(s) (at location B)
129 Light sources
130 Serpentine pattern
131 Straight portion in first direction
132 Straight portion in second direction
134 Turn-around portion
140 Mobile apparatus
141 First edge
142 Second edge
143 Chassis
145 First rotational direction (forward)
146 First position
147 Second position
148 Line
149 Center of rotation
151 First wheel
152 Second wheel
153 Ball
154 Hub
155 Motor
156 Shaft
157 Rotary encoder
158 Radial line(s)
159 Elongated line
160 Photo detector
161 Hollow tube
162 Laser
163 Cylindrical package
165 Incident beam
166 Reflected beam
167 Motor gear
168 Wheel gear
170 Controller
175 Power source
180 Operating device
182 Printhead
184 Printhead die
186 Array of nozzles
190 Photosensor array
A Location
B Location
C Location
d distance
α angle
β angle
h distance

1. A position-referenced mobile system comprising:
a mobile apparatus including:
a chassis having a first edge and a second edge opposite the first edge;
a first wheel rotatably mounted proximate the first edge of the chassis;
a second wheel rotatably mounted proximate the second edge of the chassis;
a first motor for rotating the first wheel;
a second motor for rotating the second wheel;
a first encoder for monitoring an amount of rotation of the first motor;
a second encoder for monitoring an amount of rotation of the second motor;
a laser mounted on the chassis; and
a photo detector mounted on the chassis;
a controller for interpreting signals provided by the photo detector; and
a plurality of reflective elements disposed at a corresponding plurality of locations that are observable by the photo detector when the mobile apparatus is located within a position detection region.

2. The position-referenced mobile system of claim 1, wherein the plurality of locations of the plurality reflective elements are proximate to but outside of the position detection region.

3. The position-referenced mobile system of claim 1, wherein the photo detector is disposed within a hollow tube.

4. The position-referenced mobile system of claim 1, wherein a color filter is disposed proximate the photo detector.

5. The position-referenced mobile system of claim 1, wherein a reflective surface of at least one of the reflective elements is cylindrical.

6. The position-referenced mobile system of claim 1, wherein the laser includes a cylindrical package.

7. The position-referenced mobile system of claim 1, wherein the photo detector is disposed within a hollow tube and the laser is oriented along a direction that is parallel to the hollow tube.

8. The position-referenced mobile system of claim 7, wherein the laser is adjacent to the hollow tube.

9. The position-referenced mobile system of claim 7, wherein the hollow tube is perpendicular to or substantially perpendicular to a line joining a central portion of the first wheel and a central portion of the second wheel.

10. The position-referenced mobile system of claim 1, wherein the controller is configured to provide instructions to the first motor and the second motor.

11. The position-referenced mobile system of claim 10, wherein the first motor and the second motor are configured to drive the first wheel and the second wheel independently of each other in either a forward direction or a reverse direction.

12. The position-referenced mobile system of claim 1, wherein the mobile apparatus includes a device for performing an operation directed by the controller as a function of a detected position of the mobile apparatus.

13. The position-referenced mobile system of claim 12, wherein the device includes a marking device.

14. The position-referenced mobile system of claim 12, wherein the device includes an array of nozzles for ejecting drops of liquid.

15. The position-referenced mobile system of claim 12, wherein the device includes a cutting device.

16. The position-referenced mobile system of claim 12, wherein the device is configured to perform the operation on a medium with which the first wheel and the second wheel are in contact.

17. The position-referenced mobile system of claim 1, wherein the mobile apparatus further includes a power source.

18. The position-referenced mobile system of claim 1, wherein the controller is mounted on the mobile apparatus.

19. A position-referenced mobile system comprising:
a mobile apparatus including:
a chassis having a first edge and a second edge opposite the first edge;
a first wheel rotatably mounted proximate the first edge of the chassis;
a second wheel rotatably mounted proximate the second edge of the chassis;
at least a first motor for rotating the first wheel and the second wheel;
at least a first encoder for monitoring an amount of rotation of either a shaft of the first motor or the first wheel; and
a photo detector mounted on the chassis;
a controller for interpreting signals provided by the photo detector; and
a plurality of light providing elements disposed at a corresponding plurality of locations that are observable by the photo detector when the mobile apparatus is located within a position detection region.
